(19) United States
(12) Patent Application Publication
(10) Pub. No.: US 2018/0307092 A1
(43) Pub. Date: Oct. 25, 2018

(54) DISPLAY APPARATUS

(71) Applicant: Innolux Corporation, Miao-Li County (TW)

(72) Inventors: Ming-Yen Lin, Miao-Li County (TW); Ming-Feng Hsieh, Miao-Li County (TW); Chun-Hsu Lin, Miao-Li County (TW); Chieh-Ying Chen, Miao-Li County (TW)

(21) Appl. No.: 15/935,205

(22) Filed: Mar. 26, 2018

(30) Foreign Application Priority Data
Apr. 20, 2017 (CN) 201710262303.4

(51) Int. Cl. G02F 1/1335; F21V 8/00

(52) U.S. Cl. CPC G02F 1/133504; G02F 1/133528; G02B 6/0055; G02B 6/0053; G02B 6/0051; G02F 2001/133562; G02F 2001/133567; G02F 2202/28; G02F 2201/54; G02F 2202/022; G02B 6/0056

(57) ABSTRACT

A display apparatus includes a display cell, a first optical structure and a second optical structure respectively disposed beneath and above the display cell. The first optical structure includes a first polarizer film, an adhesive layer, a prism structure having at least a prism sheet, and a lower diffuser layer. The adhesive layer has a first haze in a range of 60%-99%. The adhesive layer is disposed between the first polarizer film and the prism structure. The lower diffuser layer is disposed at one side of the prism structure which is farther away from the adhesive layer, and the lower diffuser layer has a second haze in a range of 60%-99%.

This application claims the benefit of People's Republic of China application Serial No. 201710262303.4, filed Apr. 20, 2017, the subject matters of which are incorporated herein by references.

### BACKGROUND

### Technical Field

The disclosure relates in general to a display apparatus, and more particularly to a display apparatus with a thinner exterior.

### Description of the Related Art

Electronic products with display panel, such as smart phones, tablets, notebooks, monitors, and TVs, have become indispensable necessities to modern people no matter in their work, study or entertainment. With a flourishing development of the portable electronic products, the consumers not only pursue better electronic characteristics such as higher display quality, higher speed of response, longer life span and higher reliability, but also have higher expects on the functions of the products to be more diversified. Moreover, it is an important matter to the consumers whether the electronic products are light-weight and easy to carry. The conventional displays typically have considerable thicknesses. Thus, it is important to develop a display apparatus with a thinner exterior.

### SUMMARY

The disclosure is directed to a display apparatus, comprising an integrated structure of optical films for being attached to a polarizer film, wherein the display apparatus applied by the embodied design achieves the concealing and light-condensing effects, and also has advantages of light weight and a thinner exterior.

According to one embodiment of the present disclosure, a display apparatus is provided, comprising a display cell, a first optical structure and a second optical structure respectively disposed beneath and above the display cell. The first optical structure comprises a first polarizer film, an adhesive layer, a prism structure comprising at least one prism sheet, and a lower diffuser layer. The adhesive layer has a first haze in a range of 60% to 99%, and is disposed between the first polarizer film and the prism structure. The lower diffuser layer is disposed at one side of the prism structure which is farther away from the adhesive layer, and the lower diffuser layer has a second haze in a range of 60% to 99%.

The disclosure will become apparent from the following detailed description of the preferred but non-limiting embodiments. The following description is made with reference to the accompanying drawings.

### BRIEF DESCRIPTION OF THE DRAWINGS

FIG. 1 is a cross-sectional view of a display apparatus according to one embodiment of the disclosure.

FIG. 2 is a cross-sectional view of the adhesive layer and part of the prism structure of the display apparatus of FIG. 1.

FIG. 3A and FIG. 3B illustrate if the display apparatus of the embodiment is in the warpage conditions.

FIG. 4 is a cross-sectional view of a curved display apparatus according to another embodiment of the disclosure.

### DETAILED DESCRIPTION

In the embodiments of the present disclosure, a display apparatus is provided by adopting a design of an integrated structure of optical films attached to a polarizer film, wherein the hazes of an adhesive layer and a lower diffuser layer enable the product in application to achieve the concealing and light-condensing effects. Moreover, the product applied with the embodied structure has advantages of light weight, a thinner exterior and excellent display quality. Also, the manufacturing process is simple process, which is suitable for mass production. The embodiments are described in details with reference to the accompanying drawings. It is noted that the details of the structures of the embodiments are provided for exemplification, and the described details of the embodiments are not intended to limit the present disclosure. It is noted that not all embodiments of the disclosure are shown. Modifications and variations can be made without departing from the spirit of the disclosure to meet the requirements of the practical applications. Thus, there may be other embodiments of the present disclosure which are not specifically illustrated. Further, the accompany drawings are simplified for clear illustrations of the embodiment; sizes and proportions in the drawings are not directly proportional to actual products, and shall not be construed as limitations to the present disclosure. Thus, the specification and the drawings are to be regard as an illustrative sense rather than a restrictive sense. Also, the identical and/or similar elements of the embodiments are designated with the same and/or similar reference numerals.

Moreover, use of ordinal terms such as “first”, “second”, “third”, etc., in the specification and claims to modify an element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

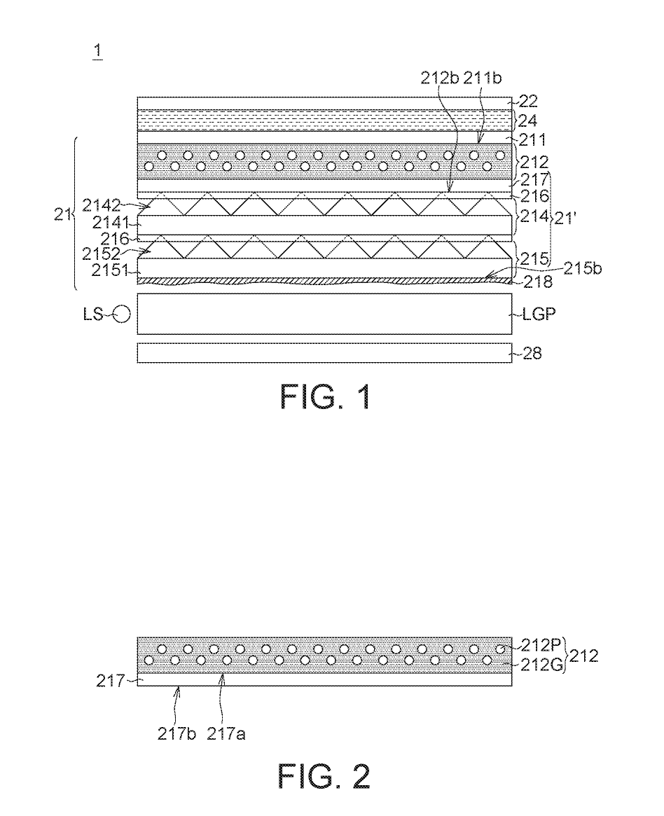

FIG. 1 is a cross-sectional view of a display apparatus according to one embodiment of the disclosure. The display apparatus 1 of the embodiment includes a first optical structure 21, a second optical structure 22, and a display cell 24 disposed between the first optical structure 21 and the second optical structure 22. The first optical structure 21 includes a first polarizer film (i.e. a lower polarizer film) 211; an adhesive layer 212, having a first haze in a range of 60% to 99%; a prism structure 21′, comprising at least one prism sheet (e.g. the prism structure 21′, for example, comprising the first prism sheet 215/the second prism sheet 214/the third base layer 217 and the glue layer 216 as described hereinafter); and a lower diffuser layer 218 disposed at one side of the prism structure 21′ and away from the adhesive layer 212, wherein the lower diffuser layer 218 has a second haze in a range of 60% to 99%. The adhesive layer 212 is disposed between the first polarizer film 211 and the prism structure 21′. In one embodiment, the adhesive layer 212 can be adhered to the first polarizer film 211 (such as attached directly to the first polarizer film 211). In another embodiment, the adhesive layer 212 can be adhered to the prism structure 21′, and the prism structure 21′ is then adhered to the first polarizer film 211 through the adhesive layer 212. The prism structure 21′ and the lower diffuser layer 218 can be adhered to the polarizer film (i.e. the first polarizer film 211) by the adhesive layer 212, so as to form a first optical structure 21 as a whole, thereby achieving the concealing and light-condensing effects. Thus, the product applied with the embodied structure has advantages of a light weight, a thinner exterior and a narrower frame of a display.

The display cell 24 described herein is referred to the upper and lower substrates and a display medium layer (such as a liquid crystal layer) disposed between the two substrates, wherein the polarizer are not included. Also, a side-type (i.e. edge-lit) backlight module is illustrated in FIG. 1, the backlight module is disposed beneath the first optical structure, and the backlight module including a light guide plate LGP is disposed beneath the lower diffuser layer 218 and a light source LS is positioned at one side of the light guide plate LGP, but the disclosure has no limitation for the type of backlighting technology. The backlight module of the embodied display apparatus can be a direct-type backlight module (ex: a light source is positioned beneath the first optical structure 21) or an edge-type backlight module for providing light for the display apparatus. The display apparatus 1 may also include a reflective layer 28 disposed beneath the light guide plate LGP. The light guide plate LGP is eliminated when a direct-type backlight module is applied to the embodied display apparatus. Additionally, the prism structure 21′ of FIG. 1 comprising two prism sheets (the second prism sheet 214/the first prism sheet 215) is depicted for illustration; however, the disclosure has no limitation for the configuration and type of the prism structure in applications.

As shown in FIG. 1, the first polarizer film 211 is disposed beneath the lower surface of the display cell 24, and the adhesive layer 212 is disposed between the lower surface 211b of the first polarizer film 211 and the prism structure 21′. Also, the lower diffuser layer 218 is disposed at a lower side of the prism structure 21′ (such as disposed on the lower surface 215b of the first prism sheet 215). In one embodiment, the adhesive layer 212, the prism structure 21′(ex: the third base layer 217/the glue layer 216/the second prism sheet 214/the glue layer 216/the first prism sheet 215) and the lower diffuser layer 218 are integrated into one adhesion piece as a whole for attaching to the lower surface 211b of the first polarizer film 211.

FIG. 2 is a cross-sectional view of the adhesive layer and part of the prism structure of the display apparatus of FIG. 1. Please refer to FIG. 1 and FIG. 2. In one embodiment, the adhesive layer 212 comprises an adhesive base layer 212G and a plurality of light-diffusing particles 212P. A base layer (such as a third base layer 217) has a smooth upper surface (such an upper surface 217a) for coating of the adhesive base layer 212G. The adhesive base layer 212G can be a pressure sensitive adhesive (PSA), but the disclosure is not limited thereto. The adhesive base layer 212G can be formed on the prism structure 21′ (such as formed on the third base layer 217) by coating or other forming ways. As shown in FIG. 1 and FIG. 2, the adhesive layer 212 is disposed between the prism structure 21′ and the first polarizer film 211, wherein the light-diffusing particles 212P are dispersed in the adhesive base layer 212G for producing haze of the adhesive layer 212.

In one embodiment, material examples of the light-diffusing particles 212P include (but are not limited to) one or more of poly(methyl methacrylate)(PMMA), methyl methacrylate (MMA), azobisisobutyronitrile (AIBN), benzoyl peroxide (BPO), trimethylolpropane triacrylate (TMPTA), nano titanium oxide (TiO₂) and silicon(IV) oxide (SiO₂). Other materials which enable the adhesive layer to reach a first haze in the range of 60% to 99% are applicable as the materials of the light-diffusing particles 212P.

In one embodiment, the adhesive base layer 212G can be a pressure sensitive adhesive, but the disclosure is not limited thereto. The pressure sensitive adhesives can be divided into three categories: the rubber system, the acrylic polymer system, and the silicone polymer system, according to the main ingredients. The pressure sensitive adhesives can be divided into four categories: solvent-based adhesives, water-based adhesives, hot-melted adhesives and radiation cured adhesives, according to the types of products. Different kinds of adhesives show their own advantages and disadvantages. The adhesive material is selected appropriately depending on the conditions and requirements of the practical application, as long as the light-diffusing particles 212P can be dispersed in the adhesive base layer 212G and able to adhere to the lower surface 211b of the first polarizer film 211.

Furthermore, in one embodiment, a prism structure 21′ consists of several prism sheets and a third bas layer 217 having a smooth surface (217a). Take the prism structure 21′ of FIG. 1 as an example, the first prism sheet 215 includes a first base layer 2151 and several first prism bodies 2152 disposed on the first base layer 2151, and the second prism sheet 214 includes a second base layer 2141 and several second prism bodies 2142 disposed on the second base layer 2141. The second prism sheet 214 is disposed on the first prism sheet 215. The glue layer 216 is a UV curing resin, provided for adhering two prism sheets and also adhering the second prism sheet 214 to the lower surface 217b of the third bas layer 217. After adhesion, the prism bodies 2142 and 2152 do not completely sink into the glue layer 216 and loss the light condensing function. Also, the glue layer 216 is not limited to a UV curing resin, and other material can be adopted in the application for being a glue layer as long as the prism bodies would not loss the light condensing function.

Additionally, the lower diffuser layer 218 can be adhered to the lower surface (ex: the lower surface 215b of the first prism sheet 215) of the prism structure 21′ by back coating, thereby integrating the lower diffuser layer 218 and the prism structure 21′ as a whole. Examples of the back coating of the lower diffuser layer 218 include matte backcoating and beads backcoating. In one example of matte backcoating, a glue is coated on a lower surface of a base layer of the prism sheet (ex: the lower surface 215b of the first base layer 2151 of the first prism sheet 215), followed by transforming a random pattern on a roller to the glue layer through embossing roll. In one example of beads backcoating, several beads are distributed at a lower surface of a base layer of the prism sheet, which enables the lower diffuser layer to have a second haze in a range of 60% to 99%. The disclosure has no particular limitation to the manufacture of the lower diffuser layer 218 in the application, and any manufacturing method is applicable as long as the lower diffuser layer 218 can be integrated with the prism structure 21′.

According to the descriptions of the embodiments above, several optical composite materials integrated as a whole is attached to a lower polarizer film (i.e. the first polarizer film 211), and the optical composite materials may include an adhesive layer 212 comprising an adhesive base layer 212G (such as PSA) adhered to the lower polarizer film and a plurality of light-diffusing particles 212P dispersed in the adhesive base layer 212G. Also, the adhesive layer 212 having a haze (La first haze) in a range of 60% to 99% not only provides concealing function (able to replace the concealing function of the conventional diffuser plates), but also achieve the attachment between the optical films and the polarizer. Also, the optical composite materials may further include a lower diffuser layer 218 having a haze (i.e. the second haze) in a range of 60% to 99%, which is able to replace the concealing function of the conventional lower diffuser plate.

Additionally, the first haze and the second haze can be the same or different, depending on the conditions and actual needs in practical applications. For example, the first haze of the adhesive layer 212 and/or the second haze of the lower diffuser layer 218 can be adjusted independently according to the brightness requirement of the display apparatus in application; the disclosure has no particular limitation thereto. In some applications, when the adhesive layer 212 has the first haze in a range of 60% to 99%, the brightness of the center of the positive viewing angle can be brighter. In some applications, when the adhesive layer 212 has the first haze in a range of 70% to 99%, the display apparatus has larger viewing angle. In some applications, when the adhesive layer 212 has the first haze in a range of 80% to 99%, it provides better concealing effect. In some applications, when the adhesive layer 212 has the first haze in a range of 80% to 90%, it prevents the display apparatus from showing the interference fringes caused by the optical films. Similarly, in one of applications, when the lower diffuser layer 218 has the second haze in a range of 60% to 99%, the brightness of the center of the positive viewing angle can be brighter. In one of applications, when the lower diffuser layer 218 has the second haze in a range of 70% to 99%, the display apparatus has larger viewing angle. In one of applications, when the lower diffuser layer 218 has the second haze in a range of 80% to 99%, it provides better concealing effect. In one of applications, when the lower diffuser layer 218 has the second haze in a range of 80% to 90%, it improves the display quality by preventing the display apparatus from showing the interference fringes caused by the optical films. The aforementioned positive viewing angle refers to a viewing angle when the angle between the visual extension lines of the observer's two eyes and the normal line of the display screen is an acute angle and lies between 0 to 5 degrees, based on the normal line of the display screen of the display apparatus.

Moreover, materials which are less sensitive to the thermal expansion and contraction can be selected for forming the base layers of the prism structure 21′(such as the first base layer 2151, the second base layer 2141 and the third base layer 217). For example, the material having no more than 5% of the thermal shrinkage in x/y/z direction at a temperature of 150° C. can be selected. In one embodiment, the material of the base layer of the prism structure has 0%-5% of the thermal shrinkage at 150° C. (the thermal shrinkage is measured by the method described in JIS 02318). In one application for mass production, the material of the base layer of the prism structure has 2%-5% of the thermal shrinkage at 150° C. In one preferred embodiment, the material of the base layer of the prism structure has 0%-2% of the thermal shrinkage at 150° C.

In one embodiment, materials of the base layers of the prism structure can be polyethylene terephthalate (PET) or polyethylene naphthalate (PEN). The thermal shrinkage of PEN is better than the thermal shrinkage of PET at the same temperature, and the water resistance of PEN is also better than the water resistance of PET. It is noted that the disclosure is not limited to those materials, and other materials suitable for making the base layers of the prism structure are also applicable.

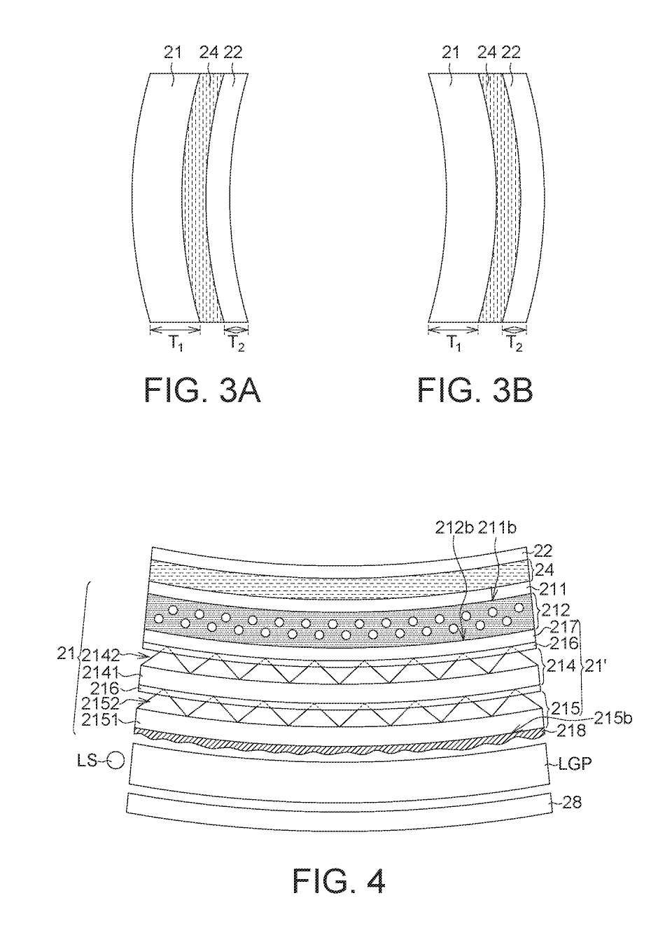

Besides the characteristics of thermal expansion and contraction of the prism structure 21′, the thicknesses of the first optical structure 21 and the second optical structure 22 respectively disposed beneath and above the display cell 24 can be considered, for improving the whole apparatus without occurrence of unwanted warpage due to the temperature change. FIG. 3A and FIG. 3B illustrate if the display apparatus of the embodiment is in the warpage conditions. For the display apparatus of the embodiment, the first optical structure 21 (such as adhered to one side of a TFT substrate) and the second optical structure 22 (such as adhered to one side of a CF substrate) are adhered to two sides of the display cell 24 (such as a LCD cell), respectively. If the overall thicknesses of the two optical structures are not matched (ex: large differences between the thicknesses and materials thereof), the base layer (ex: PET-base layer) on which the films of the TFT substrate are formed expands at high temperature, and it would leads to the inward warpage of the display cell 24, as shown in FIG. 3A. Similarly, the base layer (ex: PET-base layer) on which the films of the TFT substrate are formed contracts at low temperature, and it would leads to the outward warpage of the display cell 24, as shown in FIG. 3B. After several thermal shocks, unbalanced internal stress would cause the display cell 24 to warp and deform, which results in light leakage at four corners and affects the quality of the display image. Therefore, the warpage and/or deformation of the display apparatus can be solved or prevented by selecting materials with lower thermal shrinkage for making the base layers, and/or adjusting the thicknesses of the first optical structure 21 and the second optical structure 22 respectively disposed at two sides of the display cell 24.

In one embodiment, the thickness of the nearest base layer to the first polarizer 211 is adjusted, such as the thickness of the third base layer 217 is reduced, for preventing the warpage phenomena. In one example, the thickness of the third base layer 217 is smaller than 4T (=100 μm). In another example, the thickness of the third base layer 217 is in a range of 0.1T (=2.5 μm) to 2T (=50 μm). In another example, the thickness of the third base layer 217 is in a range of 20 μm to 60 μm. In another example, the thickness of the third base layer 217 is in a range of 1T (=25 μm) to 2T (=50 μm).

In one embodiment, besides reducing the thickness of the third base layer 217 of the prism structure 21′, the thicknesses of the prism sheets are also adjusted; for example, one or both of the first base layer 2151 and the second base layer 2141 are thinned. In one embodiment, each of the first base layer 2151 and the second base layer 2141 has a thickness less than 4T (=100 μm). In another embodiment, the thickness of the base layer (i.e. the first base layer 2151 or the second base layer 2141) is in a range of 0.1T (=2.5 μm) to 2T (=50 μm). In another embodiment, the thickness of the base layer is in a range of 20 μm to 60 μm. In another embodiment, the thickness of the base layer is in a range of 1T (=25 μm) to 2T (=50 μm).

It is noted that each of the optical films (referred to any transparent films used in the display apparatus (not including the display screen and touch screen), such as the diffuser film, prism film, brightness enhancement film, protection film, polarizers and other transparent films) adopted in the conventional display apparatus at least has a thickness of about 100 μm (=4T) or more (ex: the overall thickness of three-layered structure is about 12T). In the display apparatus of the embodiment, the thickness of each of the third base layer 217, the first base layer 2151 and the second base layer 2141 can be reduced to a range of 1T to 2T (i.e. the overall thickness of three-layered structure is in a range of 3T to 6T), or even less than 1T. Therefore, the thickness balance between the first optical structure 21 and the second optical structure 22 respectively disposed at two sides of the display cell 24 can be achieved, thereby improving even preventing the warpage phenomena of the display apparatus. Moreover, since the thicknesses of the base layers of the embodied display apparatus are reduced, the weights can be decreased, so that a thin and lightweight electronic product can be obtained by applying an embodied display apparatus. In one embodiment, a difference between an overall thickness T1 of the first optical structure 21 and an overall thickness T2 of the second optical structure 22 is in a range of 5 μm to 400 μm.

Besides reducing the overall thickness T1 of the first optical structure 21 disposed beneath the display cell 24 (such as reducing the thickness of the PET-base layer nearest to the polarizer), it is also applicable to increase the overall thickness T2 of the second optical structure 22, by disposing one or more protection films (ex: soft or hard films) for example, in order to achieve the balance between the thicknesses of the first optical structure 21 and the second optical structure 22 respectively disposed at two sides of the display cell 24. In one embodiment, the second optical structure 22 is a second polarizer film (ex: an upper polarizer film). In another embodiment, the second optical structure 22 further comprises at least one protection film (not depicted in the drawings) disposed on the side of the second polarizer film and away from the display cell 24 (i.e., the second polarizer film is disposed between the protection film and the display cell 24). The one or more protection films can be an anti-fingerprint film, an anti-static film, an anti-reflective film or a film with other function. Disposition of the protection film(s) can increase the overall thickness T2 of the second optical structure 22, thereby improving even preventing the warpage phenomena of the display apparatus.

Moreover, the disclosure can be applied to a flat display apparatus or a curved display apparatus. FIG. 4 is a cross-sectional view of a curved display apparatus according to another embodiment of the disclosure. It is noted that the disclosure is not limited to the curved type of the display apparatus as shown in FIG. 4, other embodiments such as a display apparatus in opposite curved shape or with an inflection point are also applicable. Structural configurations of FIG. 4 and FIG. 1 are identical except the curvatures. Also, the identical elements of FIG. 4 and FIG. 1 are designated with the same reference numerals. Please refer to FIG. 1 and related descriptions above for the structure details and spatial arrangements of the layers/components in FIG. 4, and the contents are not redundantly repeated.

In practical application, a multi-layered structure comprising the prism structure and the lower diffuser layer in the well-attached condition is provided. The upper and lower polarizer films are attached to the display cell 24, followed by attaching the adhesive layer having a haze (i.e. the first haze) and attaching the multi-layered structure. Alternatively, the adhesive layer having a haze (i.e. the first haze) is adhered to the polarizer film, and then adhered to the multi-layered structure, followed by adhering to the display cell 24 (this method can reduce the assembly steps of the display apparatus in mass production).

According to the aforementioned descriptions, the display apparatus of the embodiment comprises the adhesive layer 212, the prism structure 21′ and the lower diffuser layer 218, which can be integrated into one adhesion piece as a whole, and then is adhered to a polarizer film (i.e. the first polarizer film 211). The concealing effect and light adjustment (such as light-condensing effects) can be achieved by the hazes of the adhesive layer 212 and the lower diffuser layer 218. In one embodiment, the thickness of the third base layer 217 and/or other base layers (such as the second base layer 2141/the first base layer 2151) can be reduced. Compared to at least 100 μm thick or more of a base layer for disposing optical films in the conventional display apparatus, an electronic product with a light weight, a thinner exterior and a narrower frame can be obtained by applying an embodied display apparatus with the thickness-reduced base layer(s). Also, the warpage phenomena of the display apparatus can be improved even prevented completely. Therefore, a thin and lightweight display apparatus with excellent display quality can be achieved by applying the integrated film design of the embodiment, and the manufacturing process is simple and suitable for mass production.

Structural details of the aforementioned embodiments are provided for exemplification only, not for limitation. Other embodiments with different configurations, such as change on components of the related layers and the displaying elements to meet practical requirements can be applicable. It is known by people skilled in the art that the configurations and the procedure details of the related components/layers could be adjusted according to the requirements and/or manufacturing steps of the practical applications.

In the aforementioned embodiments, the technique features described in one embodiment are not limited to the application of that embodiment. It is, of course, noted that the features of different embodiments can be combined and rearranged without departing from the spirit and scope of the present disclosure.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display apparatus, comprising:
a display cell;
a first optical structure and a second optical structure, disposed beneath and above the display cell respectively, and the first optical structure comprising:
a first polarizer film;
an adhesive layer, having a first haze in a range of 60% to 99%;
a prism structure, comprising at least one prism sheet, wherein the adhesive layer is disposed between the first polarizer film and the prism structure; and
a lower diffuser layer, disposed at one side of the prism structure, wherein the one side of the prism structure is farther away from the adhesive layer, and the lower diffuser layer has a second haze in a range of 60% to 99%.

2. The display apparatus according to claim 1, wherein the adhesive layer comprises:
an adhesive base layer, disposed between the prism structure and the first polarizer film; and
a plurality of light-diffusing particles, dispersed in the adhesive base layer.

3. The display apparatus according to claim 2, wherein the adhesive base layer is a pressure sensitive adhesive.

4. The display apparatus according to claim 1, wherein the prism structure comprises a base layer, and the adhesive layer is disposed on the base layer, wherein the base layer comprises polyethylene terephthalate or polyethylene naphthalate.

5. The display apparatus according to claim 1, wherein the prism structure comprises a base layer, and the adhesive layer is disposed on the base layer, wherein a thickness of the base layer is in a range of 20 μm to 60 μm.

6. The display apparatus according to claim 1, wherein a difference between a total thickness of the first optical structure and a total thickness of the second optical structure is in a range of 5 μm to 400 μm.

7. The display apparatus according to claim 1, wherein the second optical structure comprises:
a protection film;
a second polarizer film, disposed between the protection film and the display cell.

8. The display apparatus according to claim 1, wherein the first haze of the adhesive layer is in a range of 70% to 99%.

9. The display apparatus according to claim 1, wherein the lower diffuser layer is adhered to a lower surface of the prism structure by back coating.

10. The display apparatus according to claim 1, wherein at least the adhesive layer, the prism structure and the lower diffuser layer of the first optical structure are integrated into one adhesion piece as a whole.

11. The display apparatus according to claim 1, wherein the adhesive layer is disposed between a lower surface of the first polarizer and the prism structure.

12. The display apparatus according to claim 1, wherein the lower diffuser layer is disposed at a lower side of the prism structure.

13. The display apparatus according to claim 1, wherein the first haze is in a range of 70% to 99%.

14. The display apparatus according to claim 1, wherein the first haze is in a range of 80% to 99%.

15. The display apparatus according to claim 1, wherein the first haze is in a range of 80% to 90%.

16. The display apparatus according to claim 1, wherein the at least one prism sheet comprises:
a first prism sheet; and
a second prism sheet disposed on the first prism sheet.

17. The display apparatus according to claim 1, further comprising:
a backlight module disposed beneath the first optical structure.

18. The display apparatus according to claim 17, wherein the backlight module comprises a light guide plate, and the light guide plate is disposed beneath the lower diffuser layer.

19. The display apparatus according to claim 18, wherein the backlight module further comprises a reflective layer, and the reflective layer is disposed beneath the light guide plate.
